(19) United States
(12) Patent Application Publication
(10) Pub. No.: US 2014/0025217 A1
(43) Pub. Date: Jan. 23, 2014

(54) DEVICE AND METHOD FOR SELF-HEALING CONTROL OF A MULTI-LEVEL POWER GRID

(71) Applicants: Shuqiang Jin, Zhuhai City (CN); Yuehai Liu, Zhuhai City (CN); Yongqiang Zhang, Zhuhai City (CN)

(72) Inventors: Shuqiang Jin, Zhuhai City (CN); Yuehai Liu, Zhuhai City (CN); Yongqiang Zhang, Zhuhai City (CN)

(73) Assignee: ZHUHAI UNITECH POWER TECHNOLOGY CO., LTD., Zhuhai City, Guangdong (CN)

(21) Appl. No.: 14/007,630

(22) PCT Filed: Apr. 22, 2011
(86) PCT No.: PCT/CN2011/073172

§ 371 Date: Sep. 25, 2013

(30) Foreign Application Priority Data
Mar. 25, 2011 (CN) 201110074255.9

(51) Int. Cl. G05B 13/02

(52) U.S. Cl. CPC G05B 13/02
USPC 700/295; 700/297

(57) ABSTRACT

A device and method for self-healing control of multi-level power grid system are provided in the present invention. The requirements to be satisfied by the present invention are that: realizing interaction and balance between power supplies and loads; controlling and coordinating cooperation coordination and cooperation between various distributed power supplies, micro-grids in multi-levels and their main grids; automatically distinguishing an on-grid state or an isolated island state of a locale grid; and guaranteeing energy supply to the maximum. The device for self-healing control of multi-level power grid is connected in one or more levels of power grids of the multi-level power grid system, and the device includes: a parameter acquiring and monitoring unit, a central processing unit, a human-machine interface and configuration parameter setting and inputting unit, and a regulating and controlling unit. Using frequency as an information carrier to characterize the connection state and the area coverage and grids levels included in the power system, the device enables the loads and the power supplies in the power grid system to distinguish the states of their localized grids by themselves, and performs to perform automatic switching or regulating according to preset strategies. Using frequency as information tie, the device balances supply and demand of power by self-adjustment between the power supplies and the loads in the system, and guarantees the automatic balance and stabilization of the power grid system both in the on-grid state and in the isolated island state.

### RELATED APPLICATION DATA

This application is the national stage entry of International Appl. No. PCT/CN2011/073172, filed Apr. 22, 2011, which claims priority to Chinese Patent Application No. 201110074255.9, filed Mar. 25, 2011. All claims of priority to these applications are hereby made, and each of these applications is hereby incorporated in its entirety by reference.

### TECHNICAL FIELD

The present application belongs to the technical field of power grid control, especially relates to device and method for self-healing control of a multi-level power grid system.

### BACKGROUND OF THE INVENTION

The nominal frequency of electric power system in China is 50 Hz. In “Quality of Electricity Supply—Permissible Deviation of Frequency for Power System” (GB/T15945-1995), it is specified that: the permissible deviation of normal frequency for power system ranges from −0.2 Hz to 0.2 Hz; and when the capacity of the power system is small, the permissible deviation may range from −0.5 Hz to 0.5 Hz, the limit of the capacity of the power system is not specified in the Standard. In “National Rules for the Supply and Consumption of Electric Power”, it is specified that: the permissible deviation of frequency of power supplied by the power supply bureau ranges from −0.2 Hz to 0.2 Hz when the capacity of the power system is 3,000,000 kW or more, and ranges from −0.5 Hz to 0.5 Hz when the capacity of the power system is less than 3,000,000 kW. In actual operations of the power systems, all over the country, the deviation of power frequency ranges from −0.1 Hz to 0.1 Hz.

In the technical field of electric power, the technical terms are defined as follows:

Standard frequency: namely, the nominal frequency of power system, which is 50 Hz in China.

Reference frequency: namely, the target frequency or the center frequency of the regulating target in the power grid. When the entire power network operates in a networked state, the reference frequencies of all networked equipment are equal to the standard frequency. When a local power grid operates in an isolated island state, its reference frequency may deviate from the standard frequency. Different reference values can be set for various levels of grids.

Frequency deviation: the deviation of the reference frequency relative to the standard frequency.

Frequency drift: the drift value of the actual operation frequency relative to the reference frequency.

Frequency drift domain values: the target control range for frequency stability regulating for the power system, which is from the negative drift to the positive drift centering on the reference frequency; when the power grid is running steadily, the real frequency is a certain value within the range which is from the negative drift to the positive drift centering on the reference frequency.

In the prior art, grids of various levels, whether networked or split, all run at the standard frequency, namely, the standard frequency is taken as the regulating target for all electric power control equipment and power management equipment, which are regulated to realize the balance between power supply and demand through manual or automatic dispatching and Automatic Generating Control (AGC), so as to keep the frequency of the power system within the range of a very small deviation up and down the standard frequency.

The power grid will be instable when fault or serious imbalance occurs, in order to maintain the stability of local grid, the power system will be split and partial loads will be shed by automatic protection devices of the power system or through manual operations, which will inevitably result in local or even large-scale blackouts. After the fault is removed, the recovery of the power supply requires operations through remote control or on-site manual operations by personnel of dispatching, substation and power distribution at all levels. Thus, the shed loads and the shed power cannot be recovered automatically in time, namely, the power grid cannot heal by itself.

In modern electric power system, the distributed power supply and on-grid micro-grids increase gradually. More especially, along with the large scaled application of clean energy and all-round construction of intelligent power grid, the complexity of coordination between various kinds of distributed power supplies, various levels of grids and the main grid has become a problem that must be solved.

The technology of under frequency load shedding is widely applied in the existing power transformation and distribution automation. When the system frequency decreases to be out of the limit, namely, when the power supply cannot satisfy the needs of all loads, the automatic protection devices shed the line loads in turn and gradually, which helps to recover the system frequency, helps the system run steadily, and gives priority to ensure power supply for important loads.

However, the recovery of the power supply requires operations through remote control or on-site manual operations by personnel of dispatching, substation and power distribution at all levels, the shed loads cannot be recovered automatically in time, namely, the power grid cannot heal by itself. Alternatively, the brake close instruction is given by the dispatching/distribution automation master station via real-time communication, so as to recover the power supply through the automatic execution by the on-site terminal devices. But this method is based on a vast real-time communication network, therefore, the cost is extremely high. What's more, in many occasions, the communication network cannot afford to cover all the switches, and the power supply need to be recovered through on-site manual operations.

### SUMMARY OF THE INVENTION

The object of the present invention is to provide a device and method for self-healing control of a multi-level power grid system, which realize interaction and balance between power supplies and loads, control and coordinate cooperation between various distributed power supplies, micro-grids in multi levels and their main grids, automatically distinguish a on-grid state or an isolated island state of the grid, and guarantee energy supply to the maximum.

The object of the present application is achieved by the following technical schemes:

A device for self-healing control of a multi-level power grid system is connected in one or more levels of power grids of the multi-level power grid and comprise:

a parameter acquiring and monitoring unit, for sampling and converting the power grid signals, acquiring parameters of electrical signals and sending the parameters and data to a central processing unit;

the central processing unit, for receiving the parameters and data from the parameter acquiring and monitoring unit, processing the parameters and data, comparing processed results with setting values, making judgments to get control decisions according to criterion, and outputting control and regulation signals to a controlling and regulating unit;

a human-machine interface and configuration parameter setting and inputting unit, for providing a human-machine interface or communication interface on site so that the parameters can be input and set by operators on site or be transferred and configured automatically and remotely, and for transmitting configuration parameters to the central processing unit for processing and logic judgments; and

the regulating and controlling unit, for receiving control instructions or regulating targets, performing regulating tasks, outputting control signals to devices to be controlled, and regulating the devices controlled in respect of power generation and frequency, power grid connecting or disconnecting, load switching, or electric power consumption.

The central processing unit includes a Micro Controller Unit (MCU) or a Digital Signal Processor (DSP), a data memory, a program memory and interface circuits; the MCU or DSP runs codes stored in the program memory, processes and performs arithmetic and logical operations for data stored in the data memory and for data and signals, which are transferred from the parameter acquiring and monitoring unit, and the human-machine interface and configuration parameter setting and inputting unit; and through the interface circuits, the central processing unit exchanges information with the regulating and controlling unit, the parameter acquiring and monitoring unit, the human-machine interface and configuration parameter setting and inputting unit.

The central processing unit includes a logic controller, which is composed of Field Programmable Gate Array, Complex Programmable Logic Device or Digital Logic Circuit and Analogical Electronics Circuit, or a combination thereof; parameters and signals, which are transferred from the parameter acquiring and monitoring unit, and from the human-machine interface and configuration parameter setting and inputting unit, are processed and logically judged by the logic controller; and then the logic controller outputs the control and regulation signals to the regulating and controlling unit to control the power or the load switching.

The device for self-healing control of a multi-level power grid system may be a load automatic switching control apparatus; wherein, the parameter acquiring and monitoring unit is a frequency acquiring and monitoring unit; the regulating and controlling unit is a load switching or regulating and controlling unit; the frequency acquiring and monitoring unit samples the power grid signals and converts the signals to acquire frequency parameters, and sends data or signals of the frequency parameters to the central processing unit; the central processing unit judges whether the load needs to be switched off or switched on, and whether the power consumption of load needs to be regulated up or down, and sends the control instructions or the regulating target to the load switching or regulating and controlling unit; the load switching or regulating and controlling unit sends control signals to switchgears of the loads to be controlled or to regulating controllers for adjustable loads, so as to switch the loads on or off, or regulate the loads to target values.

The device for self-healing control of a multi-level power grid may be a power supply control device; wherein, the parameter acquiring and monitoring unit is a frequency acquiring and monitoring unit; the regulating and controlling unit includes a regulating unit for the output power and the frequency of power supply and a controlling unit for grid connecting or disconnecting; the frequency acquiring and monitoring unit samples signals of the power grid and converts the signals to acquire the frequency parameters, and sends data or signals of the frequency parameters to the central processing unit; the central processing unit judges whether the power needs to be switched off, whether it can be connected on-grid or not, and whether the output power and the frequency need regulating, and then sends the control instructions or the regulating target to the regulating unit for the output power and frequency, or to the controlling unit for grid connecting or disconnecting, to perform the corresponding instructions.

A method for self-healing control of a multi-level power grid system, wherein, frequency parameter is used as an information carrier to characterize connection states and the coverage of grid levels of the power grid system, in order that controllers of loads and power supplies in the power grid system can distinguish the states of their grids by themselves and perform automatic switching or regulating according to preset strategies; the method includes a load automatic switching control process and a power supply control process.

The load automatic switching control process includes steps as follows: monitoring the frequency parameters of the power grid constantly; when the frequency is steady after a delay, judging which steady state area the frequency is located in and perform corresponding control strategy for the area; if steady frequency is located in an area for automatic switching on, switching the loads on automatically or increase the load to a certain value; if the steady frequency is located in a load decreasing area, shedding the load or reducing the loads to less than a certain value.

The power supply control process includes steps as follows: judging whether the grid is split from its superior main grid or not by monitoring the frequency or monitoring signals or through communications, if yes, the power supply runs aiming at realizing a regulating target of its preset island frequency, if not, the power supply runs following the frequency of the main grid.

Grade of frequency deviation and stability of all loads in the power grid are set according to the need of power supply reliability level and requirement of frequency precision: the higher the power supply reliability level of the load has, namely the shorter an average interruption duration is allowed, the higher the grade is and the larger the frequency deviation and drift tolerance are; and the lower the power supply reliability level of the load has, namely, the longer the average interruption duration is allowed, the lower the grade is and the more stable and the more precise a working frequency is required.

The frequency deviation and stability includes frequency deviation, a frequency deviation and drift tolerance, or a drift tolerance, according to one of which the grade of the frequency deviation and stability is determined; and the loads can be classified and identified by the grades, classes or codes as labels.

The level of local power grid matches grade of the frequency deviation and stability: when sub-grids of different levels in the power grid are connected with their corresponding superior main grids, the frequency of each sub-grid follows that of its corresponding superior main grid; when sub-grids of different levels in the power grid are split from their corresponding superior main grids or namely run in an isolated island state, each sub-grid runs at its preset island frequency, which deviates from standard frequency by a certain value, and inferior sub-grids of the sub-grid also follow the frequency deviation; the preset island frequency deviation of each level of power grid increases gradually along with the level of the local power grid from superior to inferior, namely, from large to small, and from the main grid to the sub-grids. The highest main grid runs at the standard frequency, and micro grid of end of the lowest power grid has the largest frequency deviation during island running

The frequency deviation includes positive frequency deviation and negative deviation; the largest frequency deviation is within certain range provided in Power Quality Standard, or is set specifically according to permissible frequency deviation of loads in the grid.

When the power grids get split due to fault or collapse, the loads are reduced or switched off in turn: during a transition state in which the power unbalances , the load are reduced or switched off in turn according to respective separate grade of frequency deviation and stability, and separate time delay set; the lower the grade is, the earlier the load is switched off, and the higher the grade is, the later the load is shed; after the power grid is split from a main grid, the power supplies in each sub-grid regulate the frequency of power generation according to the preset island frequency of the local power grid that the power supplies belong to, and regulate their output powers simultaneously; or after the power grid is split from the main grid, all power supplies of the sub-grids are cut off, and the sub-grids will run at the preset island frequency of the local power grid after starting up, connecting the spare power supply of the sub-grids and black starting the sub-grids with spare power supply; when the power grids get split due to fault or collapse, the frequency of the power supply of inferior sub-grids of the sub-grid is regulated following that of local main grid; or during the transition state, split the sub-grids and let them run in an isolated island state, and then reconnect the sub-grids on-grid from lower level to higher level.

When local power grid running in an isolated island state comes into stable equilibrium, a control device of each load monitors the frequency of the grid, and judge whether the frequency satisfies a grade of frequency deviation and stability of its own or not; if yes, the load is switched on and is restored to be connected to the grid automatically; if not, the load isn't switched on until the frequency satisfies the grade of the frequency deviation and stability of its own, namely, the load isn't switched on until a sub-grid is connected into a superior main grid; when a superior power grid is restored to supply power and after the sub-grid is synchronized and connected into it, the control device of each load monitors the frequency of the grid and the load is switched on automatically according to the grade of the frequency deviation and stability of its own; more and more loads are restored to be connected to the power supply along with the frequency trending to be standard.

The beneficial effects of the present invention are as follows:

Using frequency as an information carrier, the device and the method for self-healing control of a multi-level power grid system according to the present invention balance the supply and demand of power by self-adjustment between the power supplies and the loads in the system, and guarantee the automatic balance and stabilization of the power grid both in the on-grid state and in the isolated island state. Using frequency as an information carrier to characterize the connection state and the coverage of grid level of the power grid system, the present invention enables the loads and the power supplies in the power grid system to distinguish the states of their grids by themselves, and to perform automatic switching or regulating according to preset strategies. Without relying on expensive real-time communication network, the present invention guarantees that the power system, whether in the on-grid state or in the isolated island state, can run safely and steadily and supply energy to the maximum. The present invention realizes self healing for the power grid system at low cost. The present invention has broad application prospects in the distributed power accessing, utilization of clean energies and operation of micro grid, and achieves the coordination and the cooperation between various distributed power supplies, various levels of micro grids and the main grid, which are embodied as follows:

1. The grade of the frequency deviation and stability of all loads in the power grid are set according to the need of power supply reliability level and the requirement of the frequency precision: the higher the power supply reliability level of the load has, namely the shorter the average interruption duration is allowed, the higher the grade is and the larger the frequency deviation and drift tolerance are; and the lower the power supply reliability level of the load has, namely, the longer the average interruption duration is allowed, the lower the grade is and the more stable and the more precise the working frequency is required.

The frequency deviation and stability includes frequency deviation and/or drift tolerance, there are three combinations: frequency deviation, the frequency deviation and drift tolerance, and a drift tolerance.

The loads can be classified and identified by the grades, classes or codes, or other expressions as labels.

2. The level of the local power grid matches the grade of the frequency deviation and stability. When the sub-grids of different levels in the power grid system are connected with their corresponding superior main grids, the frequency of each sub-grid follows that of its corresponding superior main grid; when sub-grids of different levels in the power grid system are split from their corresponding superior main grids or namely run in the isolated island state, each sub-grid runs at its preset island frequency. The preset island frequency deviates from the standard frequency, which is 50 Hz in China, by a certain value which is within the limit of permissible frequency deviation of most loads, and inferior sub-grids of the sub-grid also follow the frequency deviation. The preset island frequency deviation of each level of power grid increases gradually along with the level of the local power grid from superior to inferior, namely, from large to small and from the main grid to the sub-grids. The highest main grid runs at the standard frequency, such as 50 Hz, and during running, the micro grid at the end of the lowest power grid has the largest frequency deviation, such as running at a frequency of 49.5 Hz.

A) The frequency deviation includes positive frequency deviation and negative deviation.

B) The largest frequency deviation ranges from −0.2 Hz to 0.2 Hz or from −0.5 Hz to 0.5 Hz according to Power Quality Standard, or is set specifically according to the minimum permissible tolerance of loads in the grid.

3. When the power grids get split due to fault or collapse, the loads are reduced or switched off in turn. During a transition state in which the power unbalances, every load is reduced or shed/switched off in turn according to respective separate grade of frequency deviation and stability, and separate time delay set. The lower the grade is, the earlier the load is switched off, and the higher the grade is, the later the load is shed till the power of the local sub grids in the isolated island state tends to be in equilibrium.

4. When the power grids get split due to fault or collapse, or after the power grid is split artificially from its main grid according to dispatching instructions, the power supply in each sub-grid regulates the power generation frequency according to the preset island frequency of the local power grid that the power supply belongs to, and regulates the output of electric power simultaneously.

5. Or when the power grids get split due to fault or collapse, or after the power grid is split artificially from the main grid according to dispatching instructions, all power supplies of the sub-grids are cut off, the sub-grids will run at the preset island frequency of the local power grid after starting up, connecting the spare power supply of the sub-grids and black starting the sub-grids with spare power supply.

6. When the local power grid running in the isolated island state comes into stable equilibrium, the control device of each load monitors the frequency of the grid, and judge whether the frequency satisfies the grade of the frequency deviation and stability of its own; if yes, the load is switched on and is restored to be connected to the grid automatically; if not, the load isn't switched on until the frequency satisfies the grade of the frequency deviation and stability of its own, namely, the load isn't switched on until the sub-grid is connected into the superior main grid.

7. When the superior power grid is restored to supply power and after the sub-grid is synchronized and connected into it, the control device of each load monitors the frequency of the grid and the load is switched on automatically according to the grade of the frequency deviation and stability of its own. More and more loads are restored to be connected to the power supply along with the frequency trending to be standard.

8. When the power grid gets split due to fault or collapse, or after the power grid is split artificially from the main grid, the frequency of the power supply of inferior sub-grids of the sub-grid is regulated following that of the local main grid; or during the transition state, split the sub-grids and let them run in an isolated island state, and then reconnect the sub-grids on-grid from lower level to higher level.

9. To avoid vibrations caused by repeatedly switching on and switching off, the load shedding threshold frequency and reclosing threshold frequency should be set as different values, there should be a hysteresis gap between them. Threshold of the switching may float adaptively according to the parameters and the transient behavior of the loads and the power grid. The loads can be switched jumpily, and can also be increased or decreased in steps or steplessly. Time delay can be set for the switching of the loads and the timing cooperation is fulfilled between multiple loads.

10. Using frequency as an information carrier to characterize the connection state and the coverage of grid level of the power grid system, the method above enables the controllers of loads and the power supplies in the power grid system to distinguish the states of their grids by themselves, and to perform automatic switching or regulating according to preset strategies. The present invention is not restricted to the preferred embodiments. Any control systems and control devices designed according to the method of the present invention and improvement or variations can be made without departing from the spirit and scope of the invention as defined in the claims, such as the judgment based on an overall consideration of frequency, voltage, active power, reactive power, harmonic wave and other features obtained from numerical transforms like differential and integral calculus thereof, or simplifying the coordination between single-level micro grid and the main grid of the power system.

11. The method for self-healing control of a multi-level power grid system can be fulfilled through the automatic control devices or the systems set for the loads and the power supply of the power grid. The control devices or systems should have the functions of monitoring frequency, regulating the power and frequency of the power supply, grid connecting and disconnecting control and loads switching control. The control software and hardware logic fulfill the flows and strategies of regulation and control. The dispatching and the monitoring of the power grid may fulfill the cooperating and coordinating, and set the preset island frequency and time delay and so on for the control devices and control systems automatically or manually.

### BRIEF DESCRIPTION OF THE DRAWINGS

FIG. 1 is a schematic diagram illustrating the device for self-healing control of a multi-level power grid system according to the present invention;

FIG. 2 is a schematic diagram illustrating the device for self-healing control of a multi-level power grid system according to the present invention as a load automatic switching control apparatus;

FIG. 3 is a schematic diagram illustrating the device for self-healing control of a multi-level power grid system according to the present invention as a power supply control apparatus;

FIG. 4 is a flow chart illustrating the load automatic switching control process of the method for self-healing control of a multi-level power grid system according to the present invention;

FIG. 5 is a flow chart illustrating the power supply control process of the method for self-healing control of a multi-level power grid system according to the present invention;

FIG. 6 is a flow chart illustrating the steps of the load automatic switching control process of the method for self-healing control of a multi-level power grid system according to the present invention;

FIG. 7 is a flow chart illustrating the steps of the power supply control process of the method for self-healing control of a multi-level power grid system according to the present invention;

FIG. 8 is a simplified schematic drawing illustrating a multi-level power grid system in the present invention.

### DETAILED DESCRIPTION OF THE PREFERRED EMBODIMENT

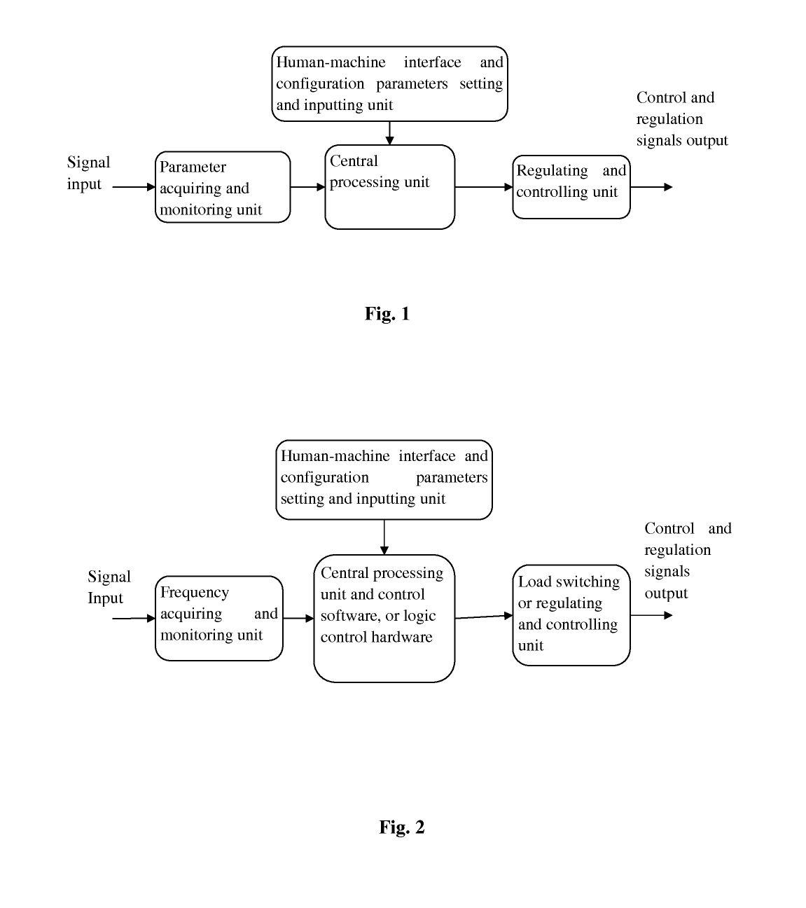

The present invention discloses a device for self-healing control of a multi-level power grid system, as shown in FIG. 1, the device for self-healing control of a multi-level power grid system is connected in one or more levels of power grids of the multi-level power grid system and comprises:

a parameter acquiring and monitoring unit, for sampling and converting the power grid signals, acquiring parameters of electrical signals and sending the parameters and data to a central processing unit;

the central processing unit, for receiving the parameters and data from the parameter acquiring and monitoring unit, processing the parameters and data, comparing the processed results with setting values, making judgments to get control decisions according to criterion, and outputting control and regulation signals to a controlling and regulating unit;

a human-machine interface and configuration parameter setting and inputting unit, for providing a human-machine interface or communication interface on site so that the parameters can be input and set by operators on site or be transferred automatically and remotely, and for transmitting configuration parameters to the central processing unit for processing and logic judgments; and

the regulating and controlling unit, for receiving control instructions or regulating targets from the central processing unit, performing regulating tasks, outputting control signals to controlled devices, and regulating the controlled devices in respect of power generation and frequency, power grid connecting or disconnecting, load switching, or electric power consumption, and so on.

The central processing unit includes a Micro Controller Unit (MCU) or a Digital Signal Processor (DSP), a data memory, a program memory and interface circuits. The MCU or DSP runs the codes stored in the program memory, performs arithmetic and logical operations for data stored in the data memory and for the data and signals, which are transferred from the parameter acquiring and monitoring unit and from the human-machine interface and configuration parameter setting and inputting unit; and through the interface circuits, the central processing unit exchanges information with the regulating and controlling unit, the parameter acquiring and monitoring unit, and the human-machine interface and configuration parameter setting and inputting unit.

The central processing unit includes a logic controller, which is composed of Field Programmable Gate Array (FPGA), Complex Programmable Logic Device (CPLD) or Digital Logic Circuit and Analogical Electronics Circuit, or a combination thereof. The parameters and signals, which are transferred from the parameter acquiring and monitoring unit and from the human-machine interface and configuration parameter setting and inputting unit, are processed and logically judged by the logic controller. Then the logic controller outputs control and regulation signals to the regulating and controlling unit for power switching or load switching control.

As shown in FIG. 2, the device for self-healing control of a multi-level power grid system is a load automatic switching control apparatus, wherein, the parameter acquiring and monitoring unit is a frequency acquiring and monitoring unit, the regulating and controlling unit is a load switching or regulating and controlling unit. The frequency acquiring and monitoring unit samples the power grid signals and converts the signals to acquire the frequency parameters, and sends the data or signals of the frequency parameters to the central processing unit. The central processing unit judges whether the load needs to be switched off or switched on, and whether the power consumption of load needs to be regulated up or down, and sends the control instructions or the regulating target to the load switching or regulating and controlling unit. The load switching or regulating and controlling unit sends the control signals to the switchgears of the loads to be controlled or to the regulating controllers for adjustable loads, so as to switch the loads on or off, or regulate the loads to target values.

As shown in FIG. 3, the device for self-healing control of a multi-level power grid system is a power supply control apparatus, wherein, the parameter acquiring and monitoring unit is a frequency acquiring and monitoring unit, the regulating and controlling unit includes a regulating unit for the output power and the frequency of power supply and a controlling unit for grid connecting or disconnecting. The frequency acquiring and monitoring unit samples signals of the power grid and converts the signals to acquire the frequency parameters, and sends the data or signals of the frequency parameters to the central processing unit. The central processing unit judges whether the power needs to be switched off, or whether the power needs to be connected on-grid or not, and whether the output power and frequency need regulating, and then sends the control instructions or the regulating target to the regulating unit for the output power and the frequency, or to the controlling unit for grid connecting or disconnecting, to perform the corresponding instructions.

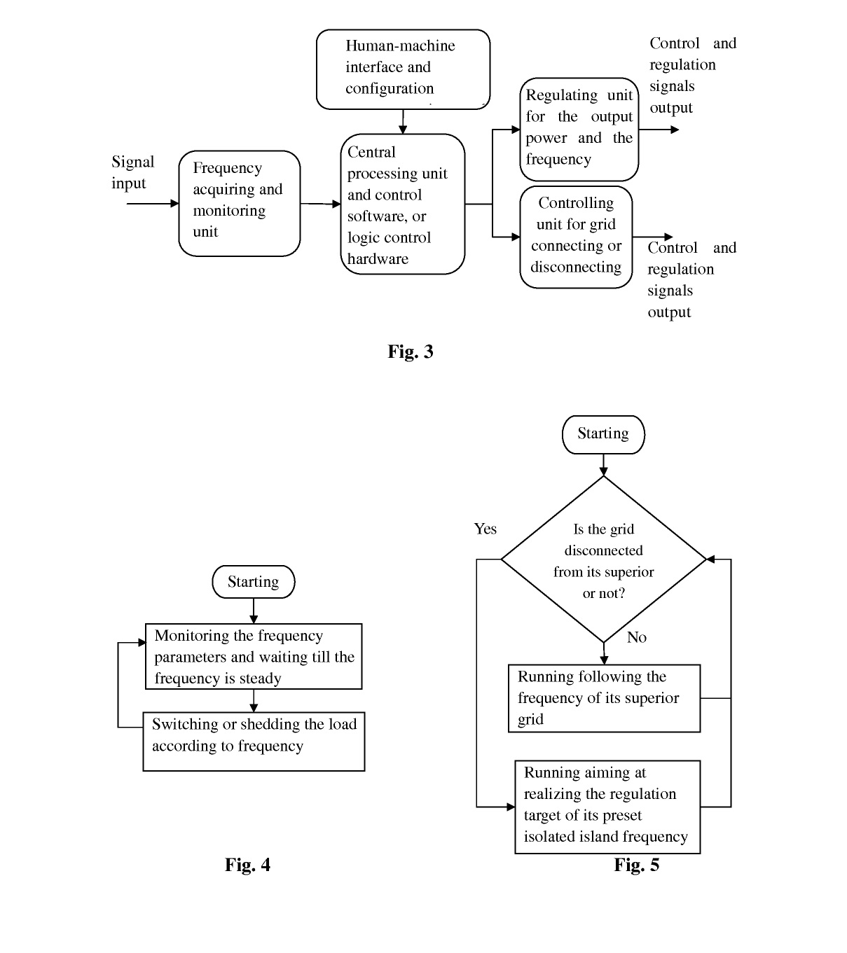

The present invention also discloses a method for self-healing control of a multi-level power grid system. As shown in FIG. 4 and FIG. 5, the frequency parameter is used as an information carrier to characterize the connection states and the coverage and grid level of the power grid system, in order that the controllers of loads and the power supplies in the power grid system can distinguish the states of their grids by themselves and perform automatic switching or regulating according to preset strategies. The method includes a load automatic switching control process and a power supply control process.

The load automatic switching control process includes steps as follows: monitor the frequency parameters of the power grids constantly; when the frequency is steady after a delay, judge which steady state area the frequency is located in and perform corresponding control strategy for the area; if the steady frequency is located in the area for automatic switching on, switch the load on automatically or increase the load to a certain value; if the steady frequency is located in the load decreasing area, shed the load or reduce the load to less than a certain value.

The power supply control process includes the steps as follows: judge whether the grid is split from its superior main grid or not by monitoring the frequency or monitoring signals or through communications, if yes, the power supply runs aiming at realizing the regulating target of its preset island frequency, if not, it runs following the frequency of the main grid.

The grade of the frequency deviation and stability of every load in the power grid is set according to the need of power supply reliability level and the requirement of the frequency precision: the higher the power supply reliability level of the load has, namely the shorter the average interruption duration is allowed, the higher the grade is and the larger the frequency deviation and drift tolerance are; and the lower the power supply reliability level of the load has, namely, the longer the average interruption duration is allowed, the lower the grade is and the more stable and the more precise the working frequency is required.

The frequency deviation and stability include frequency deviation, the frequency deviation and drift tolerance, or the drift tolerance, according to one of which the grade of the frequency deviation and stability is determined The loads can be classified and identified by grades, classes or just codes as labels.

The level of the local power grid matches the grade of the frequency deviation and stability: when the sub-grids of different levels in the power grid system are connected with their corresponding superior main grids, the frequency of each sub-grid follows that of its corresponding superior main grid; when sub-grids of different levels in the power grid system are split from their corresponding superior main grids or namely run in the isolated island state, each sub-grid runs at its preset island frequency, which deviates from the standard frequency by a certain value, and inferior sub-grids of the sub-grid also follow the frequency deviation. The preset island frequency deviation of each level of power grid increases gradually along with the level of the local power grid from superior to inferior, namely, from large to small, and from the main grid to the sub-grids. The highest main grid runs at the standard frequency, and the micro grid at the end of the lowest power grid has the largest frequency deviation during island running

The frequency deviation includes positive frequency deviation and negative deviation. The largest frequency deviation is within certain range provided in Power Quality Standard, or is set specifically according to the permissible frequency deviation of loads in the grid.

When the power grids lose stability due to fault or get split, the loads are reduced or switched off in turn: during the transition state in which the power unbalances , every load is reduced or shed in turn according to respective separate grade of the frequency deviation and stability, and separate time delay set. The lower the grade is, the earlier the load is switched off, and the higher the grade is, the later the load is shed; after the power grid is split from the main grid, the power supply in each sub-grid regulates the frequency of the power generation according to the preset island frequency of the local power grid that the power supply belongs to, and regulates the output power simultaneously. Or after the power grid is split from the main grid, all power supplies of the sub-grids are cut off, and the sub-grids will run at the preset island frequency of the local power grid after starting up, connecting the spare power supply of the sub-grids and black starting the sub-grids with the spare power supply; when the power grid lose stability due to fault or get split, the frequency of the power supply of the inferior sub-grids of the sub-grid is regulated following that of the local main grid. Or during the transition state, split the sub-grids and let them run in the island state, and then reconnect the sub-grids on-grid from lower level to higher level.

When the local power grid running in the isolated island state comes into stable equilibrium, the control device of each load monitors the frequency of the grid, and judge whether the frequency satisfies the grade of the frequency deviation and stability of its own; if yes, the load is switched on and is restored to be connected to the grid automatically; if not, the load isn't switched on until the frequency satisfies the grade of the frequency deviation and stability of its own, namely, the load isn't switched on until the sub-grid is connected into the superior main grid. When the superior power grid is restored to supply power and after the sub-grid is synchronized and connected into it, the control device of each load monitors the frequency of the grid and the load is switched on automatically according to the grade of the frequency deviation and stability of its own. More and more loads are restored to be connected to the power supply along with the frequency trending to be standard.

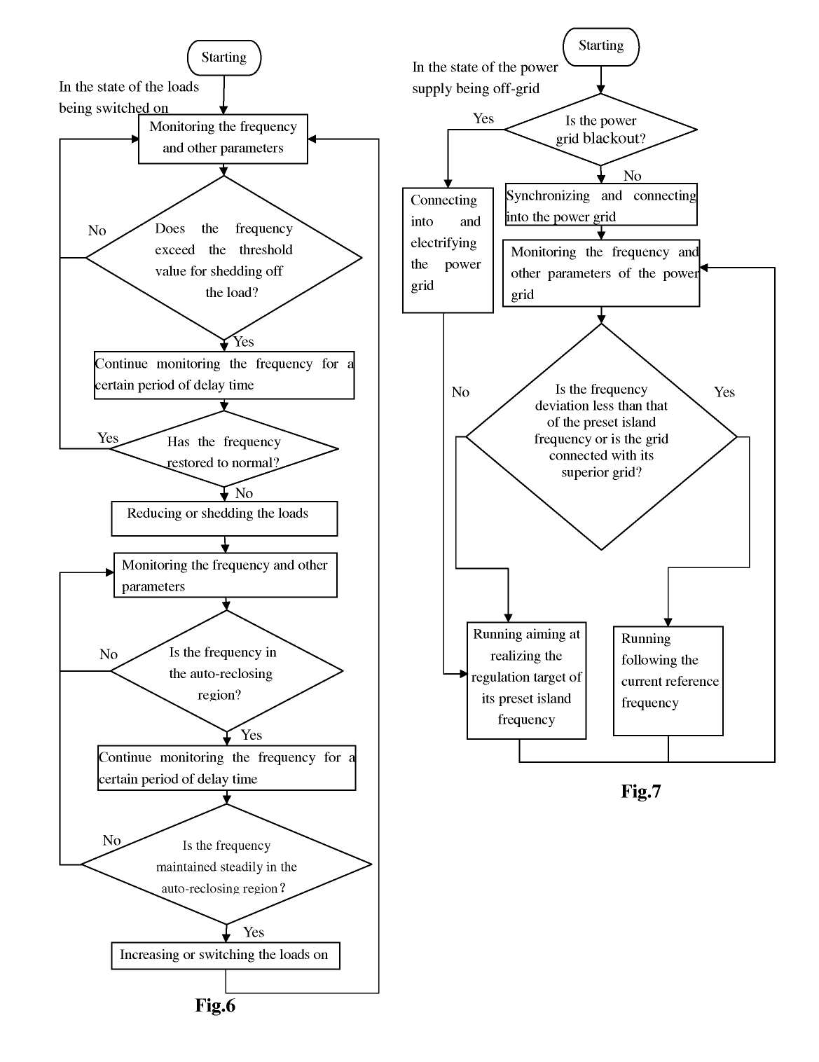

As shown in FIG. 6, the load automatic switching control process includes steps as follows

Step 1: start;

Step 2: the load automatic switching control apparatus samples and monitors the frequency parameters of the power grids constantly or processes the data to acquire comprehensive parameters;

Step 3: judge whether the frequency exceeds the threshold value for shedding off the load; if not, return to step 2; if yes, go to step 4;

Step 4: continue monitoring the frequency parameters for a certain period of delay time;

Step 5: judge whether the frequency has restored to normal or not; if yes, return to step 2; if not, go to step 6;

Step 6: control the output so as to reduce the loads to less than certain value, or turn off the electric equipment or switch off the power supply for the whole load loop;

Step 7: after reducing the load or shedding the load, the load automatic switching control apparatus continues to monitor the frequency parameters of the power grid;

Step 8: judge whether the frequency parameters are in the auto reclosing region; if not, return to step 7; if yes, go to step 9;

Step 9: continue monitoring the frequency parameters for a certain period of delay time, and judge whether the frequency is maintained steadily in the auto-reclosing region during delay; if not, return to step 7; if yes, go to step 10;

Step 10: control the output so as to increase the loads to certain value, or turn on the electric equipment or switch on the power supply for the whole load loop; and return to step 2.

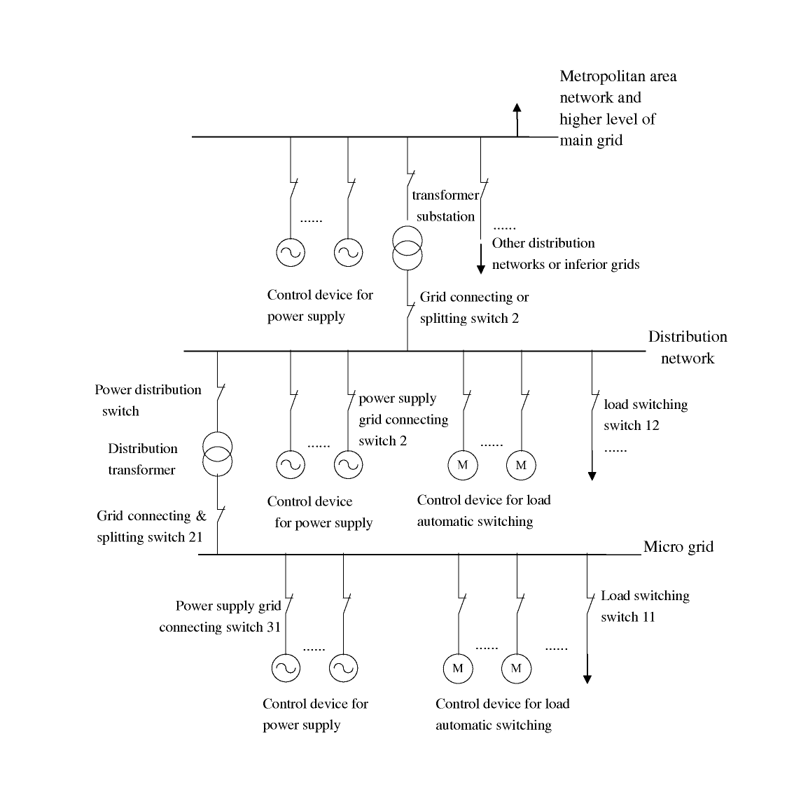

As shown in FIG. 7, the power supply control process includes the steps as follows:

Step 1: start;

Step 2: after starting the electric power equipment, monitor the power grid to be connected in order to see whether it is blackout or not; if yes, go to step 3; if not, go to step 5;

Step 3: connect into and electrify the power grid;

Step 4: the grid power supply runs aiming at realizing the regulating target of its preset isolated island frequency; go to step 6;

Step 5: synchronize and connect into the power grid according to its frequency;

Step 6: after grid connecting, sample and monitor the frequency parameters of the power grid constantly or processes the data to acquire comprehensive parameters;

Step 7: judge whether the difference between the current frequency and the standard frequency is less than the difference between the preset island frequency and the standard, namely, than the deviation of the preset island frequency of the power grid; if not, it can be judged that the gird is split from its superior grid, go to step 4; if yes, go to step 8;

Step 8: if the frequency deviation is less than the deviation of the preset island frequency of the power grid, it can be judged that the gird is connected with the superior grid, and the grid runs following the current reference frequency; and return to step 6.

FIG. 8 is a simplified schematic drawing showing one embodiment of the multi-level power grid system in the present invention. The micro grid at the end of the lowest of the power grids shown in the drawing includes lots of low voltage loads, the low voltage loads can be switched on or shed respectively through respective load switching switch 11, or can be regulated in electrical power consumption through regulating and control devices. The micro grid may further be equipped with various distributed power supplies, such as solar PV, miniature wind-mill generator, miniature gas turbine electric generating set, diesel generator set and so on, which are regulated or controlled respectively through respective control device, and which are switched on or off through respective power supply grid connecting switch 31. The micro grid is upstream connected to the medium voltage distribution network through a grid connecting and splitting switch 21. When the grid connecting and splitting switch is on, the micro grid is connected with the medium voltage distribution networks; when the switch is off, the micro grid is split from the superior grid, in this case, the micro grid is electrically supplied completely by its internal distributed power supply, that is, it runs in the isolated island state.

The distribution network may also be equipped with various distributed power supplies, which are regulated or controlled respectively through respective control device, and which are switched on or off through power supply grid connecting switch 2. The distribution network can supply power to various medium voltage devices directly, the medium voltage devices can be switched on or off respectively through respective load switching switch 12, or can be regulated in electrical power consumption through regulating and control devices; the distribution network may be downstream connected with more low voltage micro grids or loads downwards through distribution transformers that lower the voltage, and be switched on or off through power distribution switches. The distribution network is upstream connected to the superior high voltage power grid through outgoing leads from the transformer substation and the grid connecting and splitting switch 2 (namely, the switch for the outgoing leads from the transformer substation). When the grid connecting and splitting switch is on, the distribution network is connected into the main grid; when the switch is off, the distribution network is split from the superior power grid, in this case, the distribution network is electrically supplied completely by its internal distributed power supply, that is, it runs in the isolated island state.

The transformer substation is upstream connected to the metropolitan power network, and through transformer substations in other levels of grids, the transformer substation is further connected to higher levels of main grids, such as the provincial grid, the area grid, the south grid, the national grid and the national large electric grid. The transformer substation is connected with the superior main grid through its switches, or split from it to run autonomously. There are many kinds of power plants in the main grid, which are connected into through step-up transformer substations and supply electricity through power transmission lines.

The method for self-healing control of a multi-level power grid system based on frequency can be realized semi-automatically or through manual operations. For example, through observing the instrument of the frequency or based on the real-time data measured remotely, judge whether the grid of the devices is connected with the superior grid or split according to the rules above, and according to the steps above, switch off or on the loads or the power supplies manually on the site or through remote control, or regulate the power consumption of electricity or the generated output to maintain the stable operation and the balance between supply and demand of the power grid.

It should be understood that the present invention is not restricted to the preferred embodiments. Any control systems and control devices designed according to the method of the present invention, improvements or variations can be made without departing from the spirit and scope of the invention as defined in the claims. For example, technical solutions with judgments based on an overall consideration of parameters or other features obtained from numerical transformation (such as differential and integral calculus) of the parameters of frequency, voltage, active power, reactive power, harmonic wave and so on, or technical solutions with the simplified coordination between single-level micro grid and the main grid of the power system, all fall within the protection scope of the present invention.

1. A device for self-healing control of multi-level power grid system, wherein, said device is connected in one or more levels of power grids of the multi-level power grid system and comprises:
a parameter acquiring and monitoring unit, for sampling and converting the power grid signals, acquiring parameters of electrical signals and sending the parameters and data to a central processing unit;
the central processing unit, for receiving the parameters and data from the parameter acquiring and monitoring unit, processing the parameters and data, comparing processed results with setting values, making judgments to get control decisions according to criterion, and outputting control and regulation signals to a controlling and regulating unit;
a human-machine interface and configuration parameter setting and inputting unit, for providing a human-machine interface or communication interface on site so that the parameters can be input and set by operators on site or be transferred and configured automatically and remotely, and for transmitting configuration parameters to the central processing unit for processing and logic judgments; and
the regulating and controlling unit, for receiving control instructions or regulating targets, performing regulating tasks, outputting control signals to devices to be controlled, and regulating the devices controlled in respect of power generation and frequency, power grid connecting or disconnecting, load switching, or electric power consumption.

2. The device for self-healing control of a multi-level power grid system according to claim 1, wherein, the central processing unit includes a Micro Controller Unit (MCU) or a Digital Signal Processor (DSP), a data memory, a program memory and interface circuits; the MCU or DSP runs codes stored in the program memory, performs arithmetic and logical operations for data stored in the data memory and for data and signals, which are transferred from the parameter acquiring and monitoring unit and from the human-machine interface and configuration parameter setting and inputting unit; and through the interface circuits, the central processing unit exchanges information with the regulating and controlling unit, the parameter acquiring and monitoring unit, and the human-machine interface and configuration parameter setting and inputting unit.

3. The device for self-healing control of a multi-level power grid system according to claim 1, wherein, the central processing unit includes a logic controller, the logic controller is composed of Field Programmable Gate Array, Complex Programmable Logic Device or Digital Logic Circuit and Analogical Electronics Circuit, or a combination thereof; parameters and signals, which are transferred from the parameter acquiring and monitoring unit and from the human-machine interface and configuration parameter setting and inputting unit, are processed and logically judged by the logic controller; and then the logic controller outputs control and regulation signals to the regulating and controlling unit for power switching or load switching control.

4. The device for self-healing control of a multi-level power grid system according to claim 2, wherein, said device is a load automatic switching control apparatus; the parameter acquiring and monitoring unit is a frequency acquiring and monitoring unit; the regulating and controlling unit is a load switching or regulating and controlling unit; the frequency acquiring and monitoring unit samples the power grid signals and converts the signals to acquire frequency parameters, and sends data or signals of the frequency parameters to the central processing unit; the central processing unit judges whether the load needs to be switched off or switched on, and whether the power consumption of load needs to be regulated up or down, and sends the control instructions or the regulating targets to the load switching or regulating and controlling unit; the load switching or regulating and controlling unit sends control signals to switchgears of the loads to be controlled or to regulating controllers for adjustable loads, so as to switch the loads on or off, or regulate the loads to target values.

5. The device for self-healing control of a multi-level power grid system according to claim 2, wherein, said device is a power supply control apparatus; the parameter acquiring and monitoring unit is a frequency acquiring and monitoring unit; the regulating and controlling unit includes a regulating unit for the output power and the frequency of power supply and a controlling unit for grid connecting or disconnecting; the frequency acquiring and monitoring unit samples signals of the power grids and converts the signals to acquire the frequency parameters, and sends data or signals of the frequency parameters to the central processing unit; the central processing unit judges whether the power needs to be switched off, whether it can be connected on-grid or not, and whether the output power and the frequency need regulating, and then sends the control instructions or the regulating target to the regulating unit for the output power and frequency, or to the controlling unit for grid connecting or disconnecting, to perform the corresponding instructions.

6. A method for self-healing control of a multi-level power grid system, wherein, frequency parameter is used as an information carrier to characterize connection states and the coverage and grid levels of the power grid system, in order that controllers of loads and power supplies in power grid system can distinguish the states of their grids by themselves and perform automatic switching or regulating according to preset strategies; the method includes a load automatic switching control process and a power supply control process;
the load automatic switching control process includes steps as follows: monitoring the frequency parameters of the power grids constantly; when the frequency is steady after a delay, judging which steady state area the frequency is located in and perform corresponding control strategy for the area; if steady frequency is located in an area for automatic switching on, switching the loads on automatically or increase the load to a certain value; if the steady frequency is located in a load decreasing area, shedding the load or reducing the loads to less than a certain value;
the power supply control process includes steps as follows: judging whether the grid is split from its superior main grid or not by monitoring the frequency or monitoring signals or through communications, if yes, the power supply runs aiming at realizing a regulating target of its preset island frequency, if not, the power supply runs following the frequency of the main grid.

7. The method for self-healing control of a multi-level power grid system according to claim 6, wherein, grade of frequency deviation and stability of every load in the power grids is set according to the need of power supply reliability level and requirement of frequency precision: the higher the power supply reliability level of the load has, namely the shorter an average interruption duration is allowed, the higher the grade is and the larger the frequency deviation and drift tolerance are; and the lower the power supply reliability level of the load has, namely, the longer the average interruption duration is allowed, the lower the grade is and the more stable and the more precise a working frequency is required;
the frequency deviation and stability includes frequency deviation, frequency deviation and drift tolerance, or drift tolerance, according to one of which the grade of the frequency deviation and stability is determined; and the loads are classified and identified by the grades, classes or codes as labels.

8. The method for self-healing control of a multi-level power grid system according to claim 6, wherein, the level of local power grid matches grade of the frequency deviation and stability: when sub-grids of different levels in the power grids are connected with their corresponding superior main grids, the frequency of each sub-grid follows that of its corresponding superior main grid; when sub-grids of different levels in the power grids are split from their corresponding superior main grids or namely run in an isolated island state, each sub-grid runs at its preset island frequency, which deviates from standard frequency by a certain value, and inferior sub-grids of the sub-grid also follow the frequency deviation; the preset island frequency deviation of each level of power grid increases gradually along with the level of the local power grid from superior to inferior, namely, from large to small, and from the main grid to the sub-grids; the highest main grid runs at the standard frequency, and micro grid at end of the lowest power grid has the largest frequency deviation during island running;
the frequency deviation includes positive frequency deviation and negative deviation; the largest frequency deviation is within certain range provided in Power Quality Standard, or is set specifically according to permissible frequency deviation of loads in the grid.

9. The method for self-healing control of a multi-level power grid system according to claim 6, wherein, when the power grids lose stability due to fault or get split, the loads are reduced or switched off in turn: during a transition state in which the power unbalances, the loads are reduced or switched off in turn according to respective separate grade of frequency deviation and stability, and separate time delay set; the lower the grade is, the earlier the load is switched off, and the higher the grade is, the later the load is shed; after the power grid is split from a main grid, the power supplies in each sub-grid regulate the frequency of power generation according to the preset island frequency of the local power grid that the power supplies belong to, and regulate their output powers simultaneously; or after the power grid is split from the main grid, all power supplies of the sub-grids are cut off, and the sub-grids will run at the preset island frequency of the local power grid after starting up, connecting the spare power supply of the sub-grids and black starting the sub-grids with spare power supply; when the power grids lose stability due to fault or get split, the frequency of the power supply of inferior sub-grids of the sub-grid is regulated following that of local main grid; or during the transition state, split the sub-grids and let them run in an isolated island state, and then reconnect the sub-grids on-grid from lower level to higher level.

10. The method for self-healing control of a multi-level power grid system according to claim 6, wherein, when local power grid running in an isolated island state comes into stable equilibrium, a control device of each load monitors the frequency of the grid, and judge whether the frequency satisfies a grade of frequency deviation and stability of its own or not; if yes, the load is switched on and is restored to be connected to the grid automatically; if not, the load isn't switched on until the frequency satisfies the grade of the frequency deviation and stability of its own, namely, the load isn't switched on until a sub-grid is connected into a superior main grid; when a superior power grid is restored to supply power and after the sub-grid is synchronized and connected into it, the control device of each load monitors the frequency of the grid and the load is switched on automatically according to the grade of the frequency deviation and stability of its own; more and more loads are restored to be connected to the power supply along with the frequency trending to be standard.

11. The method for self-healing control of a multi-level power grid system according to claim 6, wherein, the load automatic switching control process includes steps as follows:
Step 1: starting;
Step 2: a load automatic switching control apparatus sampling and monitoring the frequency parameters of the power grids constantly or processing data to acquire comprehensive parameters;
Step 3: judging whether the frequency exceeds a threshold value for shedding off the load; if not, returning to step 2; if yes, going to step 4;
Step 4: continuously monitoring the frequency parameters for a certain period of delay time;
Step 5: judging whether the frequency has restored to normal or not; if yes, returning to step 2, keeping in the original running state and continuously monitoring the frequency parameters or other parameters; if not, going to step 6;
Step 6: controlling output so as to reduce the load to less than certain value, or turning off electric equipment or switching off the power supply for a whole load loop;
Step 7: after reducing the load or shedding the load, the load automatic switching control apparatus continuing to monitor the frequency parameters of the power grid;
Step 8: judging whether the frequency parameters are in a auto-reclosing region; if not, returning to step 7; if yes, going to step 9;
Step 9: continuously monitoring the frequency parameters for a certain period of delay time, and judging whether the frequency is maintained steadily in the auto-reclosing region during delay; if not, returning to step 7; if yes, going to step 10;
Step 10: controlling the output so as to increase the loads to certain value, or turning on the electric equipment or switching on the power supply for the whole load loop; and returning to step 2.

12. The method for self-healing control of a multi-level power grid system according to claim 6, wherein, the power supply control process includes the steps as follows:
Step 1: starting;
Step 2: after starting electric power equipment, monitoring the power grid to be connected in order to see whether it is blackout or not; if yes, going to step 3; if not, going to step 5;
Step 3: connecting into and electrifying the power grid;
Step 4: the power supply running aiming at realizing the regulating target of its preset island frequency; going to step 6;
Step 5: synchronizing and connecting into the power grid according to its frequency;
Step 6: after grid connecting, sampling and monitoring the frequency parameters of the power grid constantly or processing the data to acquire comprehensive parameters;
Step 7: judging whether a difference between a current frequency and standard frequency is less than the difference between the preset island frequency and the standard, namely, than a deviation of the preset island frequency of the power grid; if not, it can be judged that the gird is split from its superior grid, going to step 4; if yes, going to step 8;
Step 8: if the frequency deviation is less than the deviation of the preset island frequency of the power grid, it can be judged that the gird is connected with the superior grid, and the grid running following the current reference frequency; and returning to step 6.

13. The device for self-healing control of a multi-level power grid system according to claim 3, wherein, said device is a load automatic switching control apparatus; the parameter acquiring and monitoring unit is a frequency acquiring and monitoring unit; the regulating and controlling unit is a load switching or regulating and controlling unit; the frequency acquiring and monitoring unit samples the power grid signals and converts the signals to acquire frequency parameters, and sends data or signals of the frequency parameters to the central processing unit; the central processing unit judges whether the load needs to be switched off or switched on, and whether the power consumption of load needs to be regulated up or down, and sends the control instructions or the regulating targets to the load switching or regulating and controlling unit; the load switching or regulating and controlling unit sends control signals to switchgears of the loads to be controlled or to regulating controllers for adjustable loads, so as to switch the loads on or off, or regulate the loads to target values.

14. The device for self-healing control of a multi-level power grid system according to claim 3, wherein, said device is a power supply control apparatus; the parameter acquiring and monitoring unit is a frequency acquiring and monitoring unit; the regulating and controlling unit includes a regulating unit for the output power and the frequency of power supply and a controlling unit for grid connecting or disconnecting; the frequency acquiring and monitoring unit samples signals of the power grids and converts the signals to acquire the frequency parameters, and sends data or signals of the frequency parameters to the central processing unit; the central processing unit judges whether the power needs to be switched off, whether it can be connected on-grid or not, and whether the output power and the frequency need regulating, and then sends the control instructions or the regulating target to the regulating unit for the output power and frequency, or to the controlling unit for grid connecting or disconnecting, to perform the corresponding instructions.
